(19) United States
(12) Patent Application Publication
(10) Pub. No.: US 2012/0321928 A1
(43) Pub. Date: Dec. 20, 2012

(54) MECHANISM TO REDUCE THERMAL GRADIENTS IN BATTERY SYSTEMS

(75) Inventors: Broc William TenHouten, Santa Monica, CA (US); Satish Anantharaman, Tianjin (CN)

(73) Assignee: Coda Automotive, Inc., Santa Monica, CA (US)

(21) Appl. No.: 13/161,530

(22) Filed: Jun. 16, 2011

(51) Int. Cl. H01M 10/50; B21D 53/02

(52) U.S. Cl. 429/120; 29/890.03

(57) ABSTRACT

A device and method are disclosed for providing substantially uniform temperatures to at least a first and second battery cell in a battery pack. A heat transfer control element is operatively coupled to the at least first and second battery cells. The heat transfer control element is adapted to transfer heat between the battery cells and insulate the battery cells from a flow of heat transfer medium. The first battery cell is insulated to a greater amount than the second battery cell.

### FIELD

Systems and methods related to controlling the uniformity of battery cell temperatures in a battery pack, and in particular systems and methods for controlling the uniformity of battery cell temperatures in battery packs used in electric vehicles, are generally described.

### BACKGROUND

Batteries used in electric vehicles can exhibit reduced performance when they are operated outside a predetermined range of temperatures. Moreover, thermal gradients within a battery cell and/or from one battery cell to another within a pack of batteries can lead to unpredictable power, imbalanced battery cell capacities, shortened battery cell life, and in severe cases battery pack failure and possible thermal runaway events. These unwanted adverse effects may stem from different cell temperatures within the battery pack. For these reasons, among others, the ability to provide a uniform temperature to each battery cell within a battery pack is desirable.

### SUMMARY

The inventors have recognized and appreciated a need for providing substantially uniform temperatures to each battery cell within a battery pack. More generally, the inventors have recognized the advantages of providing a device and method capable of variably insulating a plurality of battery cells located along a flow of heat transfer medium to maintain each battery at substantially the same temperature.

In one exemplary embodiment, a battery pack includes at least a first and second battery cell. The battery pack also includes a heat transfer control element covering a first area of the first battery cell and a second area of the second battery cell. The first area is larger than the second area. The heat transfer control element is adapted to conduct heat between the battery cells and insulate the covered areas of the battery cells from heat transfer to a flow of heat transfer medium.

In another embodiment, a battery pack includes at least a first and second battery cell. The battery pack also includes a heat transfer control element operatively coupled to the first and second battery cells. The heat transfer control element is adapted to transfer heat between the battery cells and insulate the battery cells from a flow of heat transfer medium. The first battery cell is insulated to a greater amount than the second battery cell.

In a further embodiment, a method includes providing a battery pack comprising at least a first and second battery cell and covering a first area of the first battery cell and a second area of the second battery cell with a heat transfer control element. The first area is larger than the second area. Furthermore, the heat transfer control element is adapted to conduct heat between the battery cells and insulate the covered areas of the battery cells from heat transfer to a flow of heat transfer medium.

In another embodiment, a method includes providing at least a first and second battery cell; providing a flow of heat transfer medium to the first and second battery cells; providing a heat transfer control element disposed on the first and second battery cells; transferring heat from the first and second battery cells to a flow of heat transfer medium; and transferring heat between the first and second battery cells through the heat transfer control element. The heat transfer control element is adapted to insulate the battery cells from the flow of heat transfer medium. The first battery cell is insulated to a greater amount than the second battery cell.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 is a schematic perspective view of a battery pack with a flow of cooling medium provided to cool the battery cells;

FIG. 2 is a schematic perspective view of a battery pack with a heat transfer control element and a flow of cooling medium provided to cool the battery cells;

FIG. 3 is a schematic side view of a battery pack with a heat transfer control element and a flow of cooling medium provided to cool the battery cells;

FIG. 4 is a perspective view of a battery tray without the battery cells and showing a flow of cooling medium;

FIG. 5 is a cross-sectional view of a heat transfer control element; and

FIG. 6 is a schematic representation of a battery pack with multiple cooling pathways employing multiple heat transfer control elements.

### DETAILED DESCRIPTION

It should be understood that aspects of the invention are described herein with reference to the figures, which show illustrative embodiments in accordance with aspects of the invention. The illustrative embodiments described herein are not necessarily intended to show all aspects of the invention, but rather are used to describe a few illustrative embodiments. Thus, aspects of the invention are not intended to be construed narrowly in view of the illustrative embodiments. It should be appreciated, then, that the various concepts and embodiments introduced above and those discussed in greater detail below may be implemented in any of numerous ways, as the disclosed concepts and embodiments are not limited to any particular manner of implementation. In addition, it should be understood that aspects of the invention may be used alone or in any suitable combination with other aspects of the invention.

A heat transfer control element is adapted to provide substantially uniform battery cell temperatures within a battery pack cooled or heated by a flow of heat transfer medium. As the flow of heat transfer medium flows through the battery pack, the heat transfer medium changes temperature. In the case of a flow of cooling medium, the flow of cooling medium will warm as it flows through the battery pack. In the case of a flow of warming medium, the flow of warming medium will cool as it flows through the battery pack. This may lead to imbalanced battery cell temperatures. Therefore, to appropriately balance the heat transfer from the battery cells, the currently disclosed heat transfer control element insulates the battery cells exposed to the upstream flow of heat transfer medium to a greater amount than the battery cells exposed to the downstream flow of heat transfer medium. To further enhance the uniformity of the battery cell temperatures, the heat transfer control element is adapted to transfer heat from warmer battery cells to cooler battery cells.

In one possible embodiment, the variable insulation of the battery cells may be accomplished with a heat transfer control element that covers and insulates an area for each battery cell. In one embodiment, the covered area differs for each cell. In such a configuration, the heat transfer control element covers a greater amount of area of the battery cells exposed to the upstream flow of heat transfer medium and a lesser amount of area of the battery cells exposed to the downstream flow of heat transfer medium. The exposed areas of the battery cells are defined by the shape of the applied heat transfer control element. The exposed area of each battery cell is selected to maintain the battery cells at a substantially uniform temperature. In some embodiments, the shape of the heat transfer control element may be continuous to provide a continuous gradient in exposed area. Another possible embodiment of such a structure would be a tapered shape extending from the battery cells closest to an inlet of the flow of heat transfer medium to the battery cells closest to an exit of the flow of heat transfer medium. In other instances, the shape of the heat transfer control element may change in steps or other non-continuous shape changes. In these and other possible configurations, it is the change in shape, and thus exposed area, that leads to a control in the uniformity of the battery cell temperatures.

Another possible embodiment of the heat transfer control element controls heat transfer of the battery cells with the flow of heat transfer medium by applying a gradient in insulative properties along the flow of heat transfer medium. For such a construction the heat transfer control element provides a greater amount of insulation for the battery cells exposed to the upstream flow of heat transfer medium and a lesser amount of insulation for the battery cells exposed to the downstream flow of heat transfer medium. The gradient in insulative properties may be accomplished in any number of ways readily apparent to one of skill in the art. In one embodiment, the thickness of the heat transfer control element is varied along the length of the flow path. In another embodiment, the composition of the heat transfer control element is varied along the length of the flow path. In another embodiment, as explained, the heat transfer control element may be shaped to cover differing areas of the battery cells along the flow path. However, regardless of the specific method selected to vary the insulative properties, the gradient in insulation is selected such that the battery cells are maintained at a substantially uniform temperature across the battery pack.

While the heat transfer control element insulates the battery cells to a lesser or greater extent from the flow of heat transfer medium, the heat transfer control element may also be adapted to provide heat transfer between the battery cells. The selective heat transfer between the battery cells and insulation from the flow of heat transfer medium may be due to either an inherent directionality of the heat transfer properties of a material that the heat transfer control element is made from or the heat transfer control element may incorporate a high thermal conductivity layer. The high thermal conductivity layer should preferably either be electrically non-conductive or it should be electrically insulated from the battery cells to reduce any possible electrical connections between the battery cell exteriors. Regardless of the type of heat transfer layer selected, it is adapted to transfer heat between battery cells to help mitigate any remaining differences in temperatures through the battery pack.

Turning now to the figures, several possible embodiments are described in further detail.

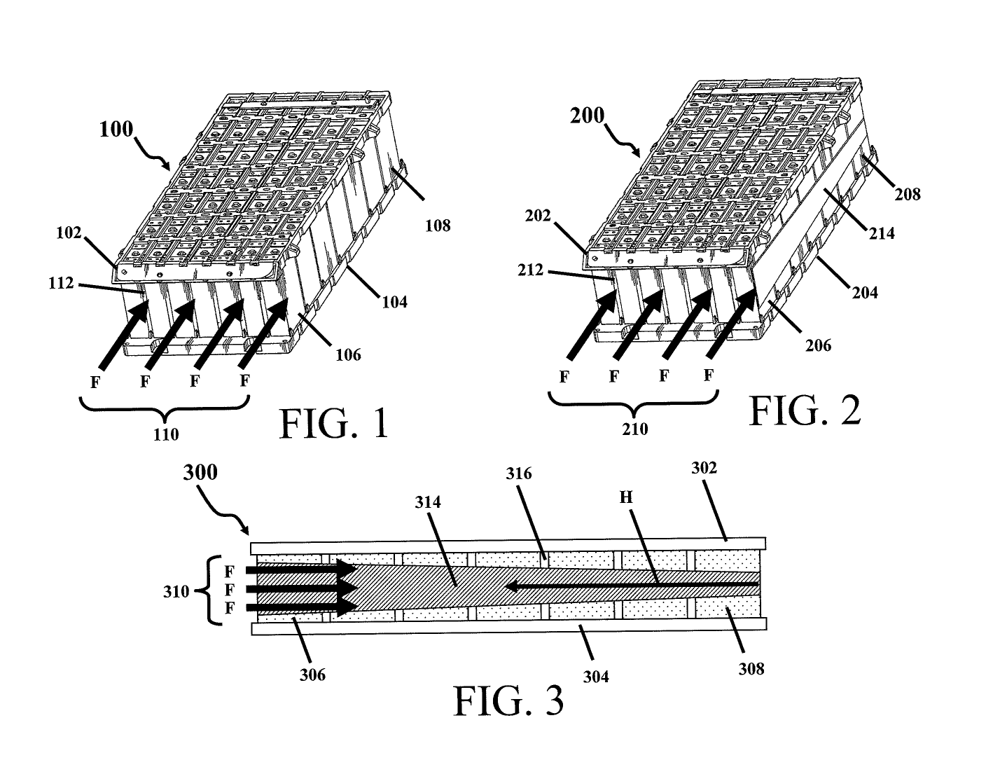

FIG. 1 depicts a perspective view of battery pack 100 with a plurality of battery cells in multiple rows and columns. The battery pack is provided with a battery cover 102 and battery tray 104 to position and hold the plurality of battery cells. The battery cells include at least a first battery cell 106 and a second battery cell 108. The first battery cell 106 is located upstream of the second battery cell 108 along a flow of heat transfer medium 110. The direction of flow is depicted by arrows F. Additionally, the first battery cell 106 may be located closer to an inlet of the flow of heat transfer medium 110 and the second battery cell 108 may be located closer to an exit of the flow of heat transfer medium 110. The heat transfer medium 110 may be used to either heat, or cool, the battery cells as required to maintain the battery cells at an appropriate working temperature.

When the flow of heat transfer medium 110 is a flow of cooling medium, it is coolest when it enters the battery pack 100 near the first battery cell 106. As the flow of cooling medium flows through the battery pack 100, heat is transferred from the plurality of battery cells to the flow of cooling medium, raising the temperature of the flow of cooling medium. Consequently, the temperature of the flow of cooling medium 110 rises as it flows through battery pack. The rise in temperature of the flow of cooling medium results in the second battery cell 108 being exposed to a warmer flow of cooling medium as compared to the first battery cell 106. When the flow of heat transfer medium 110 is a flow of warming medium, the opposite occurs, i.e. the second battery cell 108 is exposed to a cooler flow of warming medium as compared to the first battery cell 106. Without wishing to be bound by theory, the difference in temperature between the upstream and downstream portions of the flow of heat transfer medium 110 gives rise to a difference in the heat transfer efficiency from both the first battery cell 106 and second battery cell 108. Specifically, the heat transfer from the first battery cell 106 is more efficient than the heat transfer from the second battery cell 108. Disregarding other possible sources of heat and temperature non-uniformities between the battery cells themselves, the heat generation of each battery cell during a charge and discharge cycle is substantially similar. Consequently, since each battery cell generates similar amounts of heat and the heat transfer from the first battery cell 106 is more efficient than the heat transfer from the second battery cell 108, the first battery cell 106 may be cooler than the second battery cell 108 during cooling and warmer than second battery cell 108 during heating. More generally, the battery cells nearest the inlet of the flow of heat transfer medium 110 will be the coolest during cooling and warmest during heating and the battery cells nearest the outlet of the flow of heat transfer medium 110 will be the warmest during cooling and the coolest during heating.

FIG. 2 depicts a perspective view of battery pack 200 similar to the one detailed in FIG. 1. The battery pack includes a battery cover 202, a battery tray 204, a first battery cell 206, second battery cell 208, and a flow of heat transfer medium 210 depicted by arrows F. The relative positions and interactions of these elements are similar to that described above in reference to FIG. 1. However, battery pack 200 also includes a heat transfer control element 214. While heat transfer control element 214 is only depicted on the exterior edge of battery pack 200 it should be understood that a heat transfer control element may be applied to any face of a battery cell exposed to a flow of heat transfer medium. In this particular embodiment it is possible that a heat transfer control element may be applied to both sides of each air flow path 212.

In the embodiment shown in FIG. 2, heat transfer control element 214 is a film. The film insulates the battery cells from the flow of heat transfer medium 210. The film also conducts heat between each battery cell it is operatively attached to including the first battery cell 206 and the second battery cell 208 such that if a temperature difference existed between the first battery cell 206 and the second battery cell 208, the heat transfer control element 214 would conduct heat from one battery cell to the other.

The heat transfer control element 214 covers a first area of the first battery cell and a second area of the second battery cell. The first area is greater than the second area. The battery cells intermediate the first and second battery cells have covered areas ranging in size from the first to the second area. The covered area of each battery cell is selected such that the associated battery cell temperatures are substantially uniform throughout the battery pack.

In the depicted exemplary embodiment, the battery cells further away from the inlet of the flow of heat transfer medium 210 have more exposed area for heat transfer. The shape of the film is selected so that the covered area insulated from heat transfer for each battery cell gradually decreases from the inlet to the outlet of the flow of heat transfer medium 210. The exemplary heat transfer control element depicted in FIG. 2 has a substantially tapered shape extending along its length. The larger end of the tapered shape is located adjacent to the first battery cell 206. The shape of the film is not considered to be limiting for the current disclosure. Instead, the film may be any shape appropriate for providing a substantially uniform temperature among the battery cells. Furthermore, the film may be continuous in shape or may have step-wise changes in shape. The current disclosure is not limited in this fashion. The heat transfer control element 214 may also be operatively coupled to each battery cell along a flow of heat transfer medium between its inlet and outlet, or it may be applied to select battery cells. In another embodiment, the film may even have breaks between portions of the film applied to a battery cell. In such a configuration, heat could be transferred between the separated portions of the film through a single battery cell case, and then to an adjacent cell via the film bridging to that adjacent cell. In some embodiments, heat transfer control element 214 may be applied along a linear path such as the battery cell faces presented in FIG. 2. Alternatively, heat transfer control element 214 may be applied to faces of battery cells oriented in different directions along a flow path of a heat transfer medium as might be expected when a flow of heat transfer medium is directed around a corner.

FIG. 3 presents a side view of a battery pack 300. Battery pack 300 is constructed in the same manner as battery pack 200 presented in FIG. 2 and includes a battery cover 302, a battery tray 304, a first battery cell 306, a second battery cell 308, a flow of heat transfer medium 310 (the direction of flow is indicated by arrows F), and a heat transfer control element 314. The side view of battery pack 300 more clearly shows an embodiment of the heat transfer control element 314 having a tapered shape along its length and covering different areas present on the first battery cell 306 and second battery cell 308 as well as the intermediate battery cells. The side view of battery pack 300 also depicts gaps 316 present between each of the battery cells.

The tapered shape of heat transfer control element 314 results in a larger area of the upstream first battery cell 306 being covered and a smaller area of the downstream second battery cell 308 being covered. In one embodiment, heat transfer control element 314 has uniform material properties along its length, including its insulative properties with regards to flow 310. Therefore, the amount of insulation on each cell is directly proportional to the covered area. Consequently, the first battery cell 306 is insulated to a greater amount than the second battery cell 308. The battery cells intermediate the first and second battery cells have amounts of insulation ranging from the first greater amount to the second lesser amount. Of course, in another embodiment, the film may not have a uniform insulative property such that the film itself may have a uniform shape, yet the amount of heat transfer is regulated by the insulative property varying along the length of the film.

The difference in covered area for each battery cell, and thus the relative amount of insulation, effects the heat transfer from each cell to the flow of heat transfer medium 310. In addition, as detailed above, the first battery cell 306 is exposed to a cooler upstream flow of heat transfer medium during cooling and a warmer upstream flow of heat transfer medium during warming. Similarly, the second battery cell 308 is exposed to a warmer downstream flow of heat transfer medium during cooling and a cooler downstream flow of heat transfer medium during warming. Since each cell is exposed to a different temperature heat transfer medium, the covered area of each cell may be selected to balance the battery cell temperatures throughout the battery pack. In one embodiment, the cells exposed to cooler flows during cooling and warmer flows during warming are insulated to a greater amount as compared to cells exposed to warmer flows during cooling and coolerflows during warming. When appropriately selected, the above construction may result in substantially uniform battery cell temperatures throughout the battery pack.

In addition to the insulative properties discussed above, to further enhance the uniformity of the battery cell temperatures, the heat transfer control element 314 may be adapted to conduct heat between batteries along its length, as discussed above. In one embodiment, the conductance of heat along the length of heat transfer control element 314 enables heat transfer from warmer battery cells to cooler battery cells. Arrow H, in FIG. 3 indicates the transfer of heat between cells along the length of heat transfer control element 314.

To further aid heat transfer between the battery cells, in one embodiment, the gaps 316 may be filled with an optional filler material adapted to transfer heat. The filler material provides an additional heat transfer path to help mitigate any temperature differences still present in the battery cells after the application of the heat transfer control element. In certain embodiments the gap filler is a thermal gap filler comprising Boron Nitride. The filler material may also include a flame retardant appropriate for use with organic volatiles as might be found during a thermal runaway event of a battery cell. If a filler is used, the film may or may not have conductive properties to transfer heat from one cell to another.

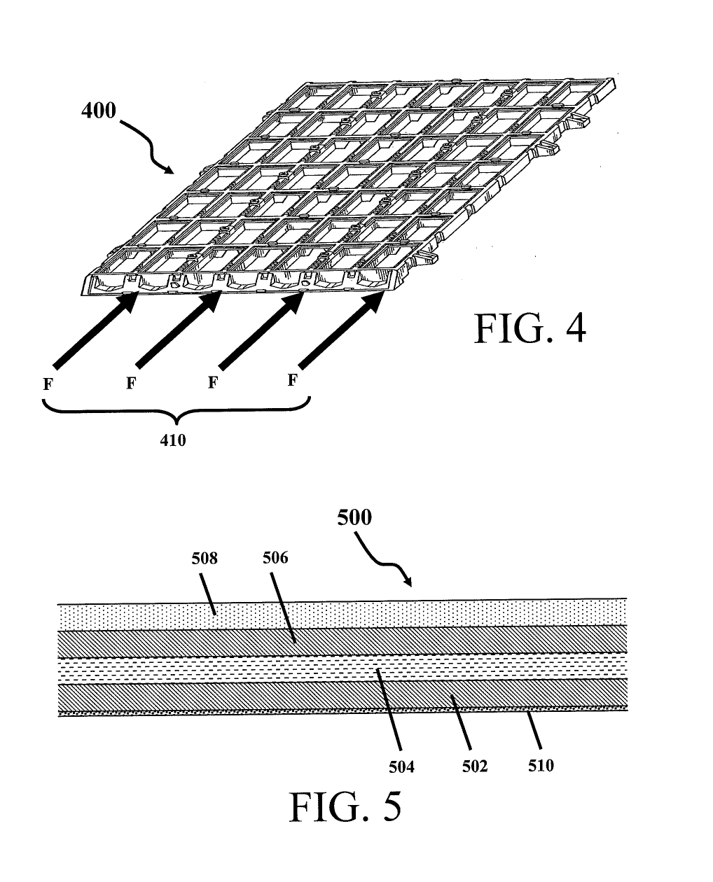

FIG. 4 depicts a battery tray 400. For battery packs located in a vehicle platform, the battery tray 400 is exposed to a flow of heat transfer medium 410 such as air flowing underneath or through the battery pack housing (not shown). The direction of flow is depicted by arrows F. In one embodiment, the battery tray 400 itself may be constructed to insulate the battery cells to a lesser or greater amount based on the location of each battery cell relative to the direction of the flow of heat transfer medium 410. Battery cells located upstream closer to the inlet of the flow of heat transfer medium 410 may be insulated to a greater amount than those battery cells located downstream closer to the outlet of the flow of heat transfer medium 410. The relative amount of insulation for each battery cell may be selected to ensure a substantially uniform temperature of each battery cell within the battery pack. The variable insulation may be designed either by variations in the thickness and/or composition of the battery tray 400. In addition to the above, battery tray 400 may be adapted to conduct heat between the battery cells. Transferring heat between warmer and cooler battery cells through battery tray 400 may further enhance the uniformity of the battery cell temperatures throughout the battery pack. While such an application of a battery tray is disclosed in reference to a vehicle mounted battery system, it is possible for such a heat transfer mechanism to be present in non-vehicle mounted applications.

FIG. 5 presents one embodiment of the layers within film 500 of a heat transfer control element as depicted in FIGS. 2 and 4. In one embodiment, film 500 includes two dielectric layers 502 and 506. Dielectric layers 502 and 506 may electrically insulate the film to avoid possible shorting hazards or electrical connection of multiple battery cell exteriors. In addition, dielectric layers 502 and 506 may act as thermal insulators in the thickness direction (i.e. between the layers). Dielectric layers 502 and 506 may be made from a polymer, ceramic, glass, paper, or other appropriate material. Film 500 may also include a high thermal conductivity layer 504 disposed between the two dielectric layers 502 and 506. High thermal conductivity layer 504 provides a heat transfer path between the battery cells that film 500 is operatively connected to. High thermal conductivity layer 504 may be made from a metal, a metallized polymer, a graphite based layer, or any other suitable high thermal conductivity material. In one possible embodiment, film 500 may be formed from, or include, a graphite tape which may have one or more integrated polymer layers. Due to the tendency of a graphite layer and/or tape to thermally and electrically insulate in the thickness direction (i.e. between the layers) and conduct heat along its length (i.e. between the cells), a film 500 incorporating a graphite layer and/or tape may, or may not, include dielectric layers 502 and 506. Examples of graphite tape include, but are not limited to, eGRAF® HITHERM™ thermal interface materials and SPREADERSHIELD™ 2-D Heat Spreaders provided by GrafTech International. The graphite tape and/or graphite based layer may be brittle and may need to be laminated with a polymer or other suitable backing material prior to use. It is possible that dielectric layers 502 and/or 506 may act as a backing material. The film may also include an optional outer insulating layer 508 capable of providing additional thermal and/or electrical insulation of the film. Outer layer 508 may provide additional thermal insulation. Outer layer 508 may also act as a backing material in place of, or in addition to, dielectric layers 502 and/or 506. Outer layer 508 may be made from a polymer or other suitable material. The film may also include a thermally conductive and electrically insulating adhesive 510 on the lower surface of dielectric layer 502 for operatively coupling the heat transfer control element to the battery cells without the need for additional adhesives or coupling methods. The relative thickness or composition of each layer may be selected to tailor the thermal properties of the film for both heat transfer between the battery cells and insulation of the battery cells from the flow of heat transfer medium.

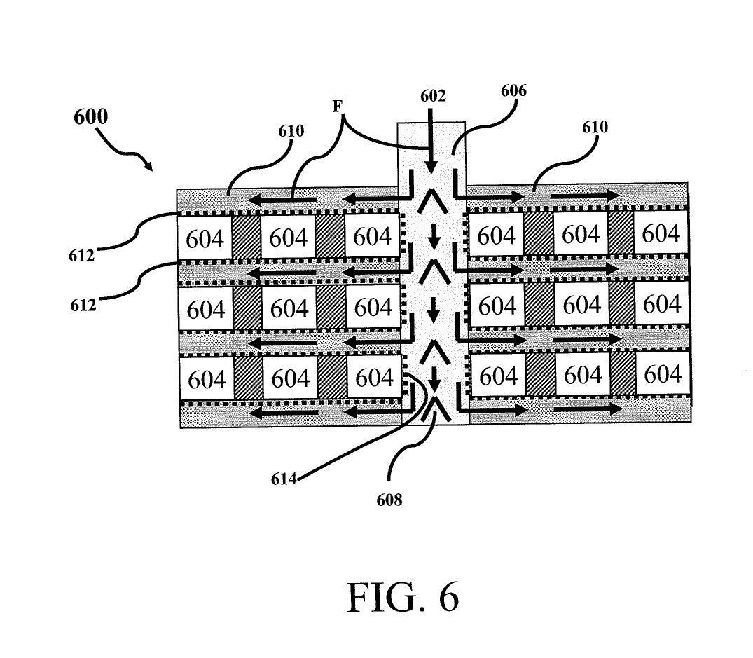

FIG. 6 presents a battery pack 600 cooled by a flow of heat transfer medium 602. The different flows of heat transfer medium are depicted by arrows F. The heat transfer medium flows through a central pathway 606. Central pathway 606 includes flow directors 608 that guide the flow of heat transfer medium 602 into the separate secondary pathways 610.

Heat transfer control elements 612 are depicted by dashed lines and are disposed on the battery cell faces along the sides of the secondary pathways 610. Heat transfer control elements 614 are also depicted by dashed lines and are disposed on battery cell faces along the side of central pathway 606. To provide uniform battery cell temperatures throughout battery pack 600, it may be necessary to insulate the battery cells 604 along shorter flow paths to a greater amount as compared to battery cells 604 located along longer flow paths. This is again due to the flow of heat transfer medium 602 progressively warming or cooling as it travels through battery pack 600 during cooling and warming cycles respectively. Therefore, longer flow paths will have larger temperature gradients than shorter flow paths. In addition to the above, the heat transfer control elements may be provided as individual or continuous sections between groups of battery cells. The heat transfer control elements may also be applied along straight sections or may be directed around bends or corners within the battery pack. One example of such a configuration could be if heat transfer control elements 612 and 614 were one continuous heat transfer control element applied to both the battery cell faces within the secondary pathways 610 as well as the battery cell face in central pathway 606. Regardless of the specific configuration selected for the heat transfer control elements, the heat transfer control element applied to each battery cell face exposed to a flow of heat transfer medium will be adapted to provide a substantially uniform battery cell temperature throughout the battery pack.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A battery pack comprising:
at least a first and second battery cell; and
a heat transfer control element covering a first area of the first battery cell and a second area of the second battery cell, wherein the first area is larger than the second area, and wherein the heat transfer control element is adapted to conduct heat between the battery cells and insulate the covered areas of the battery cells from heat transfer to a flow of heat transfer medium.

2. The battery pack of claim 1 wherein the heat conducted between the battery cells is conducted from the second battery cell to the first battery cell.

3. The battery pack of claim 1 wherein the first battery cell is located closer to an inlet of the flow of heat transfer medium than the second battery cell.

4. The battery pack of claim 1 wherein the first area and second area are selected to maintain the first and second battery cells at a substantially uniform temperature.

5. The battery pack of claim 1 wherein a shape of the heat transfer control element defines the first and second areas.

6. The battery pack of claim 1 wherein the shape of the heat transfer control element is substantially tapered along its length.

7. The battery pack of claim 1 wherein the heat transfer control element comprises a film.

8. The battery pack of claim 7 wherein the film comprises an inner dielectric layer, a high thermal conductivity layer disposed on the inner dielectric layer, an outer dielectric layer disposed on the high thermal conductivity layer, and an outer insulating layer disposed on the outer dielectric layer.

9. The battery pack of claim 1 wherein the heat transfer control element comprises a battery tray.

10. The battery pack of claim 1 wherein the heat transfer control element is operatively coupled with each battery cell between an inlet and an outlet of the flow of heat transfer medium.

11. The battery pack of claim 1 wherein the heat transfer control element is electrically insulating.

12. The battery pack of claim 1 wherein a filler is provided between the battery cells, to wherein the filler is adapted for heat transfer between the battery cells.

13. The battery pack of claim 12 wherein the filler comprises a flame retardant.

14. A battery pack comprising:
at least a first and second battery cell; and
a heat transfer control element operatively coupled to the first and second battery cells, the heat transfer control element adapted to transfer heat between the battery cells and insulate the battery cells from a flow of heat transfer medium, with the first battery cell being insulated to a greater amount than the second battery cell.

15. A method comprising:
providing a battery pack comprising at least a first and second battery cell; and
covering a first area of the first battery cell and a second area of the second battery cell with a heat transfer control element, wherein the first area is larger than the second area, and wherein the heat transfer control element is adapted to conduct heat between the battery cells and insulate the covered areas of the battery cells from heat transfer to a flow of heat transfer medium.

16. The method of claim 15 wherein the heat conducted between the battery cells is conducted from the second battery cell to the first battery cell.

17. The method of claim 15 wherein the first battery cell is located closer to an inlet of the flow of heat transfer medium than the second battery cell.

18. The method of claim 15 wherein the first area and second area are selected to maintain the first and second battery cells at a substantially uniform temperature.

19. The method of claim 15 wherein a shape of the heat transfer control element defines the first and second areas.

20. The method of claim 15 wherein the shape of the heat transfer control element is substantially tapered along its length.

21. The method of claim 15 wherein the heat transfer control element comprises a film.

22. The method of claim 21 wherein the film comprises an inner dielectric layer, a high thermal conductivity layer disposed on the inner dielectric layer, an outer dielectric layer disposed on the high thermal conductivity layer, and an outer insulating layer disposed on the outer dielectric layer.

23. The method of claim 15 wherein the heat transfer control element comprises a battery tray.

24. The method of claim 15 wherein the heat transfer control element is operatively coupled with each battery cell between an inlet and an outlet of the flow of heat transfer medium.

25. The method of claim 15 wherein the heat transfer control element is electrically insulating.

26. The method of claim 15 further comprising providing a filler between the battery cells, wherein the filler is adapted for heat transfer between the battery cells.

27. The method of claim 26 wherein the filler comprises a flame retardant.

28. A method comprising:
providing at least a first and second battery cell;
providing a flow of heat transfer medium to the first and second battery cells;
providing a heat transfer control element disposed on the first and second battery cells;
transferring heat from the first and second battery cells to the flow of heat transfer medium, wherein the heat transfer control element is adapted to insulate the battery cells from the flow of heat transfer medium, with the first battery cell being insulated to a greater amount than the second battery cell; and
transferring heat between the first and second battery cells through the heat transfer control element.
